(19) United States
(12) Patent Application Publication
(10) Pub. No.: US 2011/0185594 A1
(43) Pub. Date: Aug. 4, 2011

(54) SHOE UPPER, THE METHOD FOR PREPARING THE SAME AND THE USE THEREOF

(75) Inventors: Yuedong Zhang, Shanghai (CN); Sam Torres, Shanghai (CN); Gang Sun, Shanghai (CN); Yongdong Pang, Shanghai (CN); Roy Lin, Singapore (SG)

(73) Assignee: Bayer MaterialScience AG, Leverkusen (DE)

(21) Appl. No.: 12/993,953

(22) PCT Filed: May 19, 2009
(86) PCT No.: PCT/EP2009/003542

§ 371 Date: Apr. 19, 2011

(30) Foreign Application Priority Data
May 22, 2008 (CN) 200810037871

(51) Int. Cl. A43B 3/00; A43B 23/02; A43B 23/07; A43B 5/00; B32B 37/14; B05D 1/02

(52) U.S. Cl. 36/113; 36/45; 36/55; 156/298; 427/427.6

(57) ABSTRACT

The present invention pertains to a shoe upper, the method for preparing the same and the use thereof. This invention provides a method for preparing shoe upper by spraying polyurethane reaction system, avoids the complicated steps of cutting, shaping, stitching and bonding, simplify the production process, reduces the equipment requirements, saves cost and improves the production efficiency.

### TECHNICAL FIELD

The present invention pertains to a shoe upper, the method for preparing the same and the use thereof.

### BACKGROUND

Shoe upper making is an important process in the shoe industry. In the shoe making of sports shoes, hiking shoes and safety shoes, besides the outer layer of the shoe upper, it is necessary to add a flexible material between the shoe upper outer layer and inner layer, which directly contact foot, to improve the comfortableness for wearing and achieve the cushioning protection for the foot. In traditional shoe upper making process, the different layers were stitched or bonded together, such as a stitch method disclosed in U.S. Pat. No. 44,275 and a method to bond fabric and leather disclosed in U.S. Pat. No. 4,168,341.

U.S. Pat. No. 6,675,691, U.S. Pat. No. 997,041 and GB2275439 disclosed a method for preparing shoe upper by way of putting a cutting slab foam material as elastic material between the outer layer and inner layer. However, the cutting and shaping process of the slab foam and the succedent stitching and bonding process of the outer layer and inner layer required a complicated cutting and shaping machine and consumed a lot of working time. Furthermore, the adhesive agent used in the adhesion process would cause a potential harm for the environment and operators.

Further, U.S. Pat. No. 5,785,909 disclosed a method for preparing shoe upper by a pouring and foaming process, wherein a polyurethane reaction system were poured between the outer layer and the inner layer to form a polyurethane layer to make a shoe upper. Nevertheless, this method required a high demand with regard to the poor flow ability of the polyurethane reaction system. In addition, this method required high demand on the mold material and mold lock performance, due to the fact that more polyurethane reaction system should be poured to make the polyurethane reaction system to full fill the mold.

Therefore, it is necessary to provide a new method for preparing shoe upper to avoid the complicated steps of cutting, shaping, stitching and bonding, simplify the production process, reduce the equipment requirements, save cost and improve the production efficiency.

### CONTENTS OF INVENTION

The objective of this invention is to provide a method for preparing a shoe upper, the shoe upper comprising a first polyurethane layer, wherein, the method comprises a step of spraying a first polyurethane reaction system to form the first polyurethane layer.

The method can further comprise a step of spraying a second polyurethane reaction system onto one side of the first polyurethane layer to form a second polyurethane layer.

Another objective of this invention is to provide a shoe upper comprising a first polyurethane layer, wherein, the first polyurethane layer is formed by spraying a first polyurethane reaction system.

The shoe upper can further comprise a step of spraying a second polyurethane reaction system onto one side of the first polyurethane layer to form a second polyurethane layer.

The first polyurethane reaction system comprises:
(a) one or more polyisocyanates, wherein, the general formula of the polyisocyanates is R(NCO)n, where R is aliphatic alkyl which contains 2-18 carbon atoms, or aromatic alkyl which contains 6-15 carbon atoms, or aromatic lipid alkyl which contains 8-15 carbon atoms, and n=2-4;
(b) one or more polyols, and said polyol is selected from the group consisting of polyester polyol, polyether polyol, and aliphatic polycarbonate;
(c) one or more chain extenders; and
(d) 0.01-0.5 wt. % one or more blowing agents, based on 100 wt. % of components (b) and (c).

The second polyurethane reaction system comprises:
(a) one or more polyisocyanates, wherein, the general formula of the polyisocyanates is R(NCO)n, where R is aliphatic alkyl which contains 2-18 carbon atoms, or aromatic alkyl which contains 6-15 carbon atoms, or aromatic lipid alkyl which contains 8-15 carbon atoms, and n=2-4;
(b) one or more polyols, and said polyol is selected from the group consisting of polyester polyol, polyether polyol, and aliphatic polycarbonate;
(c) one or more chain extenders; and
(d) 0.3-4.5 wt. % one or more blowing agents, based on 100 wt. % of components (b) and (c).

The shoe upper can further comprise a leather layer, wherein, the first polyurethane layer is formed by spraying the first polyurethane reaction system onto one side of the leather layer.

The first polyurethane reaction system comprises:
(a) one or more polyisocyanates, wherein, the general formula of the polyisocyanates is R(NCO)n, where R is aliphatic alkyl which contains 2-18 carbon atoms, or aromatic alkyl which contains 6-15 carbon atoms, or aromatic lipid alkyl which contains 8-15 carbon atoms, and n=2-4;
(b) one or more polyols, and said polyol is selected from the group consisting of polyester polyol, polyether polyol, and aliphatic polycarbonate;
(c) one or more chain extenders; and
(d) 0.3-4.5 wt. % one or more blowing agents, based on 100 wt. % of components (b) and (c).

The shoe upper can further comprise an inner layer.

Another objective of this invention is to provide a shoe comprising the shoe upper. Another objective of this invention is to provide a use of the shoe upper in preparing shoes.

The advantages of this invention are that the method for preparing the shoe upper can avoid the complicated steps of cutting, shaping, stitching and bonding, simplify the production process, reduce the equipment requirements, save cost and improve the production efficiency.

### FIGURE DESCRIPTION

The figures are used to further describe the examples and methods disclosed in this invention, the figures are demonstrative but not limitative.

FIGS. 1A and 1B are the sketch maps of Example 1 provided in the present invention;

FIGS. 2A, 2B and 2C are the sketch maps of Example 2 provided in the present invention;

FIGS. 3A, 3B and 3C are the sketch maps of Example 3 provided in the present invention;

FIGS. 4A, 4B, 4C and 4D are the sketch maps of Example 4 provided in the present invention;

FIGS. 5A, 5B, 5C and 5D are the sketch maps of Example 5 provided in the present invention;

FIGS. 6A, 6B and 6C are the sketch maps of Example 6 provided in the present invention;

FIGS. 7A, 7B and 7C are the sketch maps of Example 7 provided in the present invention;

FIGS. 8A, 8B and 8C are the sketch maps of Example 8 provided in the present invention;

FIGS. 9A and 9B are the sketch maps of Example 9 provided in the present invention;

FIGS. 10A, 10B and 10C are the sketch maps of Example 10 provided in the present invention.

### MODE OF CARRYING OUT THE INVENTION

The present invention provides a method to make shoe upper by spraying polyurethane reaction system.

The present invention provides a shoe upper comprising a polyurethane outer layer, wherein, the polyurethane outer layer is formed by spraying a first polyurethane reaction system.

The shoe upper can comprise a polyurethane outer layer and a polyurethane foam layer, wherein, the polyurethane foam layer is formed by spraying a second polyurethane reaction system onto one side of the polyurethane outer layer.

The shoe upper can comprise a polyurethane outer layer, a polyurethane foam layer and an inner layer, wherein, the inner layer is, before the polyurethane foam layer is formed, attached onto the second polyurethane reaction system.

The shoe upper can comprise a polyurethane outer layer and an inner layer, wherein, the inner layer is, before the polyurethane foam layer is formed, attached onto the second polyurethane reaction system.

The shoe upper can comprise a polyurethane outer layer and a fabric layer, wherein, the polyurethane outer layer covers the two sides of the fabric layer; the polyurethane outer layer is formed by spraying a first polyurethane reaction system; the fabric layer is, before the first polyurethane layer is formed on one side, attached onto the first polyurethane reaction system sprayed on this side, thereafter, another polyurethane outer layer is formed on the other side by spraying another first polyurethane reaction system on the other side of the fabric layer.

The shoe upper can comprise a polyurethane outer layer and a pre-formed foam layer, wherein, the pre-formed foam layer is, before the first polyurethane layer is formed, attached onto the first polyurethane reaction system. The pre-formed foam layer, which is a foam layer formed in advance. The pre-formed foam layer can be formed by spraying process, cutting, pouring or other method in advance.

The thickness of the first polyurethane layer can be, but not limit to, 0.5-3.0 mm, preferably 0.8-2.0 mm, more preferably 1.0-1.3 mm, most preferably 1.1-1.2 mm.

The first polyurethane reaction system is used to prepare the polyurethane outer layer, the first polyurethane reaction system comprises:
(a) one or more polyisocyanates, wherein, the general formula of the polyisocyanates is R(NCO)n, where R is aliphatic alkyl which contains 2-18 carbon atoms, or aromatic alkyl which contains 6-15 carbon atoms, or aromatic lipid alkyl which contains 8-15 carbon atoms, and n=2-4;
(b) one or more polyols, and said polyol is selected from the group consisting of polyester polyol, polyether polyol, and aliphatic polycarbonate;
(c) one or more chain extenders; and
(d) 0.01-0.5 wt. % one or more blowing agents, based on 100 wt. % of components (b) and (c).

The second polyurethane reaction system is used to prepare the polyurethane foam layer, the second polyurethane reaction system comprises:
(a) one or more polyisocyanates, wherein, the general formula of the polyisocyanates is R(NCO)n, where R is aliphatic alkyl which contains 2-18 carbon atoms, or aromatic alkyl which contains 6-15 carbon atoms, or aromatic lipid alkyl which contains 8-15 carbon atoms, and n=2-4;
(b) one or more polyols, and said polyol is selected from the group consisting of polyester polyol, polyether polyol, and aliphatic polycarbonate;
(c) one or more chain extenders; and
(d) 0.3-4.5 wt. % one or more blowing agents, based on 100 wt. % of components (b) and (c).

The present invention provides a shoe upper, comprising a leather layer and a polyurethane foam layer, wherein, the polyurethane foam layer is formed by spraying a first polyurethane reaction system onto one side of the leather layer.

The shoe upper can comprise a leather layer, a polyurethane foam layer and an inner layer, wherein, the inner layer is, before the polyurethane foam layer is formed, attached onto the first polyurethane reaction system.

The first polyurethane reaction system is used to prepare the polyurethane foam layer, the first polyurethane reaction system comprises:
(a) one or more polyisocyanates, wherein, the general formula of the polyisocyanates is R(NCO)n, where R is aliphatic alkyl which contains 2-18 carbon atoms, or aromatic alkyl which contains 6-15 carbon atoms, or aromatic lipid alkyl which contains 8-15 carbon atoms, and n=2-4;
(b) one or more polyols, and said polyol is selected from the group consisting of polyester polyol, polyether polyol, and aliphatic polycarbonate;
(c) one or more chain extenders; and
(d) 0.3-4.5 wt. % one or more blowing agents, based on 100 wt. % of components (b) and (c).

The present invention prepares the outer layer of the shoe upper by way of spraying polyurethane reaction system. This method avoids the whole sheet cutting process in traditional shoe upper making, thus eliminates the material waste in the whole sheet cutting process.
In the present invention, the polyurethane reaction system is sprayed onto one side of the outer layer of the shoe upper to form a polyurethane foam layer, which can be used as the flexible material layer of the shoe upper to improve the wearing comfortableness and realize the cushioning protection for the foot. In addition, this method avoids the complicated steps of cutting, shaping, stitching and bonding, simplify the production process, reduce the equipment requirements, save cost and improve the production efficiency. Further more, by using of this method, the polyurethane reaction system can be foamed in situ on one side of the outer layer, therefore, this method avoids the “horizontal flow” of the polyurethane reaction system happened in the process of mold filling in traditional method and significantly reduces the product defects caused by poor flow ability of the polyurethane reaction system.

The method provided in this invention can be implemented with a shoe upper mold. In accordance with the method provided in this invention, the polyurethane layer of the shoe upper is prepared by spraying polyurethane reaction system, therefore, the requirements of the material of the mold is low, the design and manufacture cost of the shoe upper mold can be significantly reduced.

The shoe upper mold comprises at least one mold base. The polyurethane outer layer can be made by spraying the polyurethane reaction system into the shoe upper mold.

Before the polyurethane outer layer is formed by spraying the polyurethane reaction system into the shoe upper mold, a mold release agent can be used to cover the shoe upper mold to facilitate the demold process of the polyurethane outer layer.

The mold base can comprise a certain shape. The shape can be designed according to different requirements to make a shoe upper made accordantly having a shape fit for the foot.

The mold base can comprise a certain concave convex pattern or concave convex shape. The concave convex pattern or the concave convex shape can be designed according to different requirements to make a shoe upper made accordantly having a nice pattern and/or a shape fit for the foot.

The shoe upper mold can further comprise a mold lid. The mold lid is closed during the process of shoe upper making, thus the polyurethane foam layer made accordantly is adhered to the polyurethane outer layer made accordantly sufficiently.

An inner layer can be attached onto the mold lid. After the reaction of the polyurethane reaction system for preparing the polyurethane outer layer is started and before the reaction is finished, the mold lid is closed to make the inner layer attached to the polyurethane reaction system, thus the polyurethane outer layer made accordantly is adhered to inner layer made accordantly sufficiently.

Similarly, an inner layer can be attached onto the mold lid. After the reaction of the polyurethane reaction system for preparing the polyurethane foam layer is started and before the reaction is finished, the mold lid is closed to make the inner layer attached to the polyurethane reaction system, thus the polyurethane foam layer made accordantly is adhered to the inner layer made accordantly sufficiently.

The mold lid can comprise a certain shape. The shape can be designed according to different requirements to make a shoe upper made accordantly having a shape fit for the foot.

The mold lid can comprise a certain concave convex pattern or concave convex shape. The concave convex pattern or the concave convex shape can be designed according to different requirements to make a shoe upper made accordantly having a nice pattern and/or a shape fit for the foot.

The leather layer can comprise one or more kinds of leather. The leather can be selected from, but not limited to, leather and synthetic leather. The leather layer can be a whole leather sheet or a leather sheet stitched by several pieces of leather sheet. The leather sheet stitched by several pieces of leather sheet can be a leather sheet with joint seam or a leather sheet without joint seam. If the leather sheet with joint seam is used, before the polyurethane reaction system is sprayed, a polyurethane rubber adhesive agent can be applied on one side of the leather sheet with joint seam to prevent the polyurethane reaction system infiltrate into or penetrate the joint seam.

The inner layer can be selected from, but not limited to, fabric or soft skin. The fabric can be selected from, but not limited to, the Grambrelle fabric available from Dupont®, the Gore-Tex fabric available from Gore®, Sympa-Tex fabric available from Sympatex®. The soft skin can be chose from but not limit to, lambskin or pigskin.

The first and second polyurethane reaction system can be selected from, but not limited to, single component, two components or multi components polyurethane reaction system, preferably two components polyurethane reaction system. The two components polyurethane reaction system comprises isocyanates component and polyols component.

The isocyanates component comprises one or more polyisocyanates, wherein, the general formula of the polyisocyanates is R(NCO)n, where R is aliphatic alkyl which contains 2-18 carbon atoms, or aromatic alkyl which contains 6-15 carbon atoms, or aromatic lipid alkyl which contains 8-15 carbon atoms, and n=2-4.

The polyisocyanates can be selected from, but not limited to, ethylene diisocyanate, 1,4-tetramethylene diisocyanate, 1,6-hexamethylene diisocyanate, 1,2-dodecane diisocyanate, cyclobutane-1,3-diisocyanate, cyclohexane-1,3-diisocyanate, cyclohexane-1,4-diisocyanate, 1-isocyanate-3,3,5-trimethyl-5-isocyanate methyl cyclohexane, 2,4-hexahydro toluene diisocyanate, 1,3-hexahydro phenyl diisocyanate, 1,4-hexahydro phenyl diisocyanate, perhydrogenated diphenylmethane-2,4-diisocyanate, perhydrogenated diphenylmethane-4,4-diisocyanate, phenylene 1,3-diisocyanate, phenylene 1,4-diisocyanate, durene-1,4-diisocyanate, 3,3-dimethyl-4,4-diphenyl diisocyanate, methyl-2,4-diisocyanate (TDI), methyl-2,6-diisocyanate (TDI), diphenylmethane-2,4′-diisocyanate (MDI), diphenylmethane-2,2′-diisocyanate (MDI), diphenylmethane-4,4′-diisocyanate (MDI), naphthylene-1,5-diisocyanate (NDI), the mixtures thereof, the isomer thereof, the mixtures of they and the isomer thereof.

The polyisocyanates can also include polyisocyanate modified by carbon diamine, polyisocyanate modified by allophanate and polyisocyanate modified by isocyanate, the modified polyisocyanate can be selected from, but not limited to, diphenylmethane diisocyanate, diphenylmethane-2,4′-diisocyanate modifiedy by diphenylmethane diisocyanate, the mixtures thereof, the isomer thereof, the mixtures of they and the isomer thereof.

The polyisocyanates can also include isocyanate prepolymer, the method for preparing the isocyanate prepolymer is known in the prior art.

When preparing the polyurethane outer layer, the NCO content of the prepolymer can be, but not limit to, 2-18 wt. %□preferably 5-14 wt. %□more preferably 7-12 wt. %.

When preparing the polyurethane foam layer, the NCO content of the prepolymer can be, but not limit to, 8-30 wt. %□preferably 10-28 wt. %□more preferably 13-25 wt. %.

The polyols component comprises polyols, chain extender and blowing agent.

The polyol can be selected from, but not limited to, polyester polyol, polyether polyol, polycarbonate polyol and the mixtures thereof.

The polyester polyol can be made by the reaction of dicarboxylic acids or dicarboxylic acid anhydrides with polyols. The dicarboxylic acid can be selected from, but not limited to, aliphatic carboxylic acids containing 2 to 12 carbon atoms, the unlimited examples are succinic acid, malonic acid, glutaric acid, adipic acid, suberic acid, azelaic acid, sebacic acid, dodecyl carboxylic acid, maleic acid, fumaric acid, phthalic acid, isophthalic acid, terephthalic acid and the mixtures thereof. The dicarboxylic acid anhydride can be selected from, but not limited to, phthalic anhydride, tetrachlorophthalic anhydride, maleic anhydride and the mixtures thereof. The polyol can be selected from, but not limited to, glycol, diethylene glycol, 1,2-propanediols, 1,3-propanediols, dipropylene glycol, 1,3-methylpropanediol, 1,4-butanediol, 1,5-pentanediol, 1,6-hexanediol, neopentyl glycol, 1,10-decandediol, glycerol, trimethylol-propane and the mixtures thereof. The polyester polyol also includes the polyester polyols made of lactones, for example, ε-caprolactone.

The polyether polyols can be made by the process known in the prior art, for example, made by the reaction between olefin dioxide and starting agent at the present of catalyst. The catalyst can be selected from, but not limited to, alkaline hydroxide, alkaline alkoxide, antimony pentachloride, boron fluoride ether and the mixtures thereof. The olefin dioxide can be selected from, but not limited to, tetrahydrofuran, ethylene oxide, 1,2-propylene oxide, 1,2-epoxy butane, 2,3-epoxy butane, styrene oxide, epichlorohydrin and the mixtures thereof. The starting agent can be selected from, but not limited to, polyhydroxy compounds, the polyhydroxy compounds can be selected from, but not limited to, water, ethylene glycol, 1,2-propylene glycol, 1,3-propylene glycol, diethylene glycol, trimethylolpropane and the mixtures thereof.

The polycarbonate polyols can be selected from, but not limited to, polycarbonate diols. The polycarbonate diols can be made by the reaction of diols and dialkyl carbonate or diaryl carbonate or phosgene. The diols can be selected from, but not limited to, 1,2-propanediol, 1,3-propanediol, 1,4-butanediol, 1,5-pentanediol, 1,6-hexanediol, diethylene glycol, trioxanediol and the mixtures thereof. The dialkyl carbonate or diaryl carbonate can be selected from, but not limited to, diphenyl carbonate.

The chain extender, is typically selected from the active hydrogen atom containing compound having a molecular weight <800, preferably 18-400. The active hydrogen atom containing compound can be selected from, but not limited to, alkanediols, dialkylene glycols, polyols and the mixtures thereof, the unlimited examples are glycol, 1,4-butanediol, 1,6-hexanediol, 1,7-heptanediol, 1,8-octanediol, 1,9-nonanediol, 1,10-decanediol, diethylene glycol, dipropylene glycol, polyoxyalkylene glycols and the mixtures thereof. The active hydrogen atom containing compound can also include other branched chain or unsaturated alkanediols, the unlimited examples are 1,2-propanediol, 2-methyl-1,3-propanediol, 2,2-dimethyl-1,3-propanediol, 2-butyl-2-ethyl-1,3-propanediol, 2-butene-1,4-diol, 2-butyne-1,4-diol, alkanolamines, N-alkyldialkanolamines and the mixtures thereof; the N-alkyldialkanolamines can be selected from, but not limited to, ethanolamine, 2-aminopropanol and 3-amino-2,2-dimethylpropanol, N-methyl, N-ethyl-diethanolamine and the mixtures thereof. The active hydrogen atom containing compound can further include aliphatic amines, aromatic amines and the mixtures thereof, the aliphatic amines, aromatic amines can be selected from, but not limited to, 1,2-ethylenediamine, 1,3-propylenediamine, 1,4-butylenediamine, 1,6-hexamethylenediamine, isophoronediamine, 1,4-diaminocyclohexane, N,N′-diethyl-phenylenediamine, 2,4-diaminotoluene, 2,6-diaminotoluene and the mixtures thereof.

The blowing agent can be physical blowing agent and chemical blowing agent, which can be selected from, but not limited to, water, halohydrocarbon and hydrocarbon. The halohydrocarbon can be selected from, but not limited to, monochlorodifluoromethane, dichloromonofluoromethane, dichlorofluoromethane, trichlorofluoromethane and the mixtures thereof. The hydrocarbon can be selected from, but not limited to, butane, pentane, cyclopentane, hexane, cyclohexane, heptane and the mixtures thereof. The blowing agent, preferably, is water.

The amount of the blowing agent depends on the required density with regard to the polyurethane outer layer or the polyurethane foam layer.

When preparing the polyurethane outer layer, the amount of the blowing agent is 0.01-0.5 wt. %□preferably 0.03-0.3 wt. %□more preferably 0.05-0.25 wt. %, based on 100 wt. % of the amount of the polyols and chain extender comprised in the polyols component.

When preparing the polyurethane foam layer, the amount of the blowing agent is 0.3-4.5 wt. %□preferably 0.5-3.6 wt. %□more preferably 0.6-3.2 wt. %, based on 100 wt. % of the amount of the polyols and chain extender comprised in the polyols component.

The density of the polyurethane outer layer provided in the invention is 0.5-1.5 g/cm³, preferably 0.6-1.2 g/cm³, the hardness of the polyurethane outer layer provided in the invention is 10-80 Shore A, preferably 25-50 Shore A.

The density of the polyurethane foam layer provided in the invention is 0.03-0.5 g/cm³, preferably 0.05-0.4 g/cm³, more preferably 0.2-0.3 g/cm³, the hardness of the polyurethane outer layer provided in the invention is 10-60 Asker C, preferably 25-50 Asker C.

The polyols component can also comprise catalyst and surfactant.

The catalyst can be selected from, but not limited to, amine catalysts, organometallic catalysts and the mixtures thereof. The amine catalysts can be selected from, but not limited to, tertiary amine catalysts. The tertiary amine catalysts can be selected from, but not limited to, dabco, triethylamine, tributylamine, N-ethylmorpholine, N,N,N′,N′-tetramethyl-ethylenediamine, pentamethyldiethylene-triamine, N,N-methylbenzylamine, N,N-dimethylbenzylamine and the mixtures thereof. The organometallic catalysts can be selected from, but not limited to, organo-tin compounds. The unlimited examples are tin (II) acetate, tin (II) octoate, ethylhexonate tin, laurate tin, dibutyltin oxide, dibutyltin dichloride, dibutyltin diacetate, dibutyltin maleate, dioctyltin diacetate and the mixtures thereof. The dialkyl tin (IV) salt can be selected from, but not limited to, dibutyltin diacetate, dibutyltin dilaurate, dibutyltin maleate, dioctyltin diacetate and the mixtures thereof. The amount of the catalyst is 0.001-10 wt. %, based on 100 wt. % of the amount of the polyols and chain extender comprised in the polyols component.

The surfactant can be selected from, but not limited to, polyoxyalkylene derivatives of siloxane. The amount of the surfactant catalyst is 0.01-5 wt. %, based on 100 wt. % of the amount of the polyols and chain extender comprised in the polyols component.

In the polyurethane reaction system for preparing the polyurethane outer layer, the mol ratio between the NCO group and the OH group can be, but not limit to, 90-120:100, preferably 95-110:100. The OH group is counted based on all the OH group included in the polyols, chain extender and blowing agent comprised in the polyols component.

The first and second polyurethane reaction system can also be single component or multi components polyurethane reaction system. The individual component and the amount thereof in the single component or multi components polyurethane reaction system can be fixed in accordance with the components and the amount above-mentioned in the two components polyurethane reaction system.

### EXAMPLES

The spraying equipment used in the present invention can be selected from, but not limited to, single component spraying equipment, two components spraying equipment or multi components spraying equipment, preferably two components spraying equipment. The spraying equipment can be selected from, but not limited to, the hand spraying gun with integrated mixing nozzle and automatic spraying gun with integrated mixing nozzle, preferably automatic spraying gun with integrated mixing nozzle.

The spraying equipment can be selected from, but not limited to, high pressure spraying equipment and low pressure spraying equipment, wherein, the pressure of the high pressure spraying equipment is 100-300 bar, the pressure of the low pressure spraying equipment is 5-50 bar. The raw material is transported to the spraying gun by pipeline, mixed in the inner of the spraying gun and sprayed out. The spraying equipment can further comprise a heating equipment, the heating equipment can not only be equipped in the inner of the raw material storage tank, but also be equipped on the pipeline.

During the spraying process, the mol ratio between the NCO group and the OH group comprised in polyurethane reaction system can be initialized and adjusted by way of initializing and adjusting the volume ratio of the isocyanates component and the polyols component. The volume ratio can be a fixed ratio, wherein the fixed ratio can be selected from, but not limited to, 3:1□2:1□1:1□1:2□1:3. The volume ratio can also be a variable ratio, wherein the variable ratio can be changed between, but not limited to, 10:100 to 100:10.

The raw materials aforementioned and aftermentioned:

DESMODUR VP.PU 10IS14: An isocyanate prepolymer, available from Bayer;

BAYFLEX FW20FX910: A combined polyols, available from Bayer;

DESMODUR VP.PU 0309: An isocyanate prepolymer, available from Bayer;

BAYTEC 30BV09: A combined polyols, available from Bayer;

H-XP3 type high pressure spraying machine: available from GRACO Inc.□

CP54 type low pressure spraying machine: available from UNIPRE Inc.

### Example 1

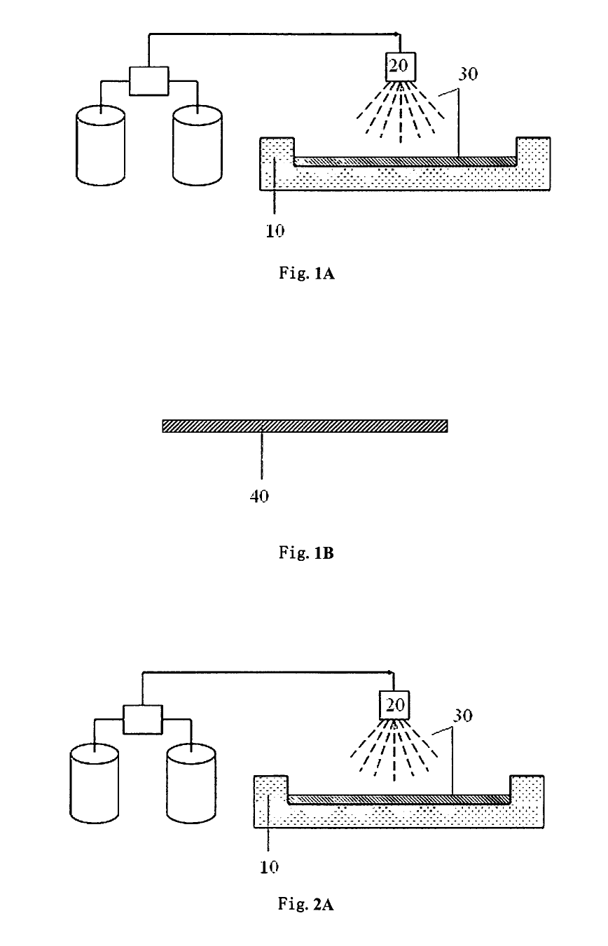

As shown in FIG. 1A, by using CP54 type low pressure spraying machine, the polyurethane reaction system 30, DESMODUR VP.PU 0309 and BAYTEC 30BV09, were sprayed by the spraying gun nozzle 20 into the cavity of mold 10 within 8 seconds to form a polyurethane outer layer. After being cured for 3 minutes and demolded, a shoe upper was obtained.
As shown in FIG. 1B, the shoe upper comprised a polyurethane outer layer 40, wherein the thickness of the polyurethane outer layer 40 was 0.8±0.1 mm. The polyurethane outer layer not only comprised a surface without flaw and a uniform thickness, but also possessed a good tactility.

### Example 2

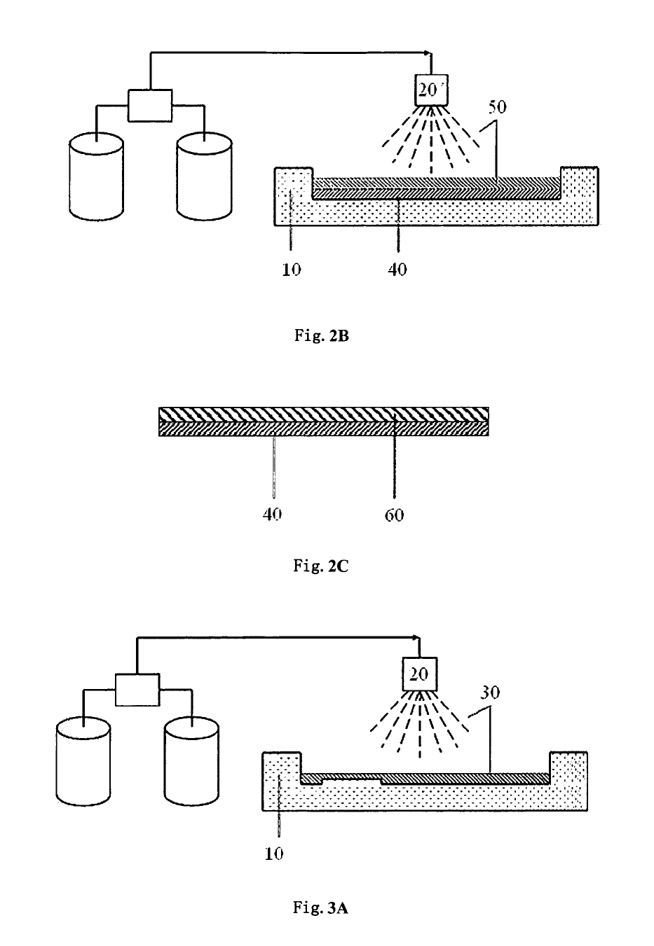

As shown in FIGS. 2A and 2B, by using CP54 type low pressure spray machine, the polyurethane reaction system 30, DESMODUR VP.PU 0309 and BAYTEC 30BV09, were sprayed by a spraying gun nozzle 20 into the cavity of mold 10 within 15 seconds to form a polyurethane outer layer 40, wherein the thickness of the polyurethane outer layer 40 was 1.0±0.1 mm.
One minute after the polyurethane outer layer 40 being formed, by using H-XP3 type high pressure spraying machine, the polyurethane reaction system 50, DESMODUR VP.PU 10IS14 and BAYFLEX FW20FX910, were sprayed by a spraying gun nozzle 20′ onto one side of the polyurethane outer layer 40 within 20 seconds. After being cured for 4 minutes and demolded, a shoe upper was obtained.
As shown in FIG. 2C, the shoe upper comprised a polyurethane outer layer 40 and a polyurethane foam layer 60. As the chemical property of the polyurethane reaction system 30 was similar to the chemical property of the polyurethane reaction system 50, there was a good adhesion effect existed between the polyurethane outer layer 40 and the polyurethane foam layer 60 without using adhesive agent. Therefore, a potential harm for environment and workers caused by using of adhesive agent was avoided. Both of the polyurethane outer layer 40 and the polyurethane foam layer 60 comprised a surface without flaw, a uniform thickness and no small hole. Both of the polyurethane outer layer 40 and the polyurethane foam layer 60 attached thereon possessed a good tactility.

### Example 3

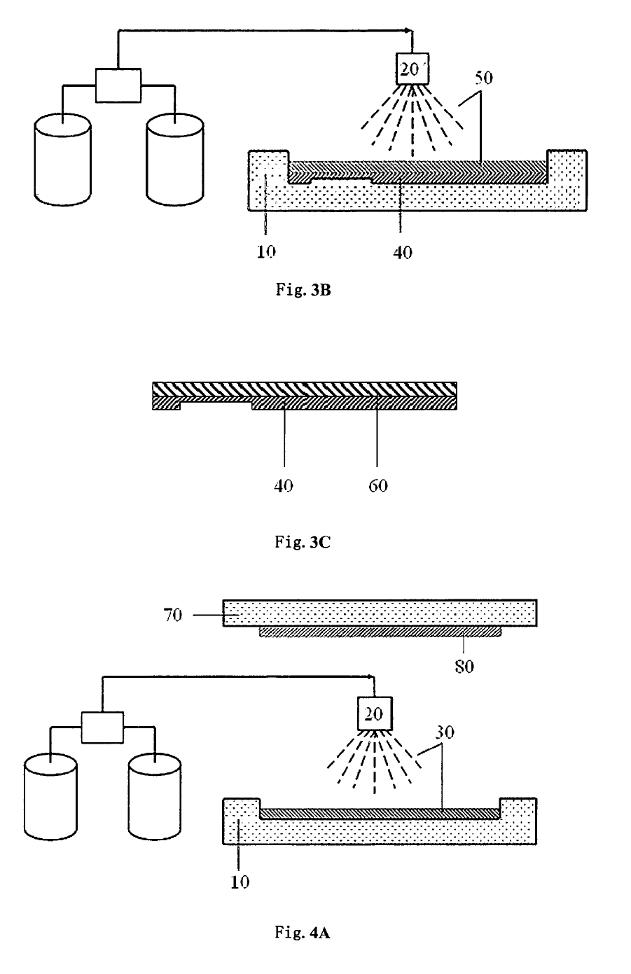

As shown in FIGS. 3A and 3B, by using CP54 type low pressure spraying machine, the polyurethane reaction system 30, DESMODUR VP.PU 0309 and BAYTEC 30BV09, were sprayed by a spraying gun nozzle 20 into the cavity of mold 10 within 20 seconds to form a polyurethane outer layer 40, wherein the thickness of the polyurethane outer layer 40 was 1.0±0.3 mm.

The mold base of the shoe upper mold 10 comprised a certain concave convex pattern or a concave convex shape, wherein the concave convex pattern or a concave convex shape can be designed according to different requirements to make the shoe upper made accordantly having a nice pattern or a shape fit for the foot. The surface of the polyurethane outer layer 40, which was obtained by spraying, comprised a convex concave pattern or convex concave shape corresponding to the concave convex pattern or a concave convex shape on the mold base of the shoe upper mold 10.
One minute after the polyurethane outer layer 40 being formed, by using H-XP3 type high pressure spraying machine, the polyurethane reaction system 50, DESMODUR VP.PU 10IS14 and BAYFLEX FW20FX910, were sprayed by a spraying gun nozzle 20′ onto one side of the polyurethane outer layer 40 within 25 seconds. After being cured for 4 minutes and demolded, a shoe upper was obtained.
As shown in FIG. 3C, the shoe upper comprised a polyurethane outer layer 40 and a polyurethane foam layer 60. As the chemical property of the polyurethane reaction system 30 was similar to the chemical property of the polyurethane reaction system 50, there was a good adhesion effect existed between the polyurethane outer layer 40 and the polyurethane foam layer 60 without using adhesive agent. Therefore, a potential harm for environment and workers caused by using of adhesive agent was avoided. Both of the polyurethane outer layer 40 and the polyurethane foam layer 60 comprised a surface without flaw, a uniform thickness and no small hole. Both of the polyurethane outer layer 40 and the polyurethane foam layer 60 attached thereon possessed a good tactility.

### Example 4

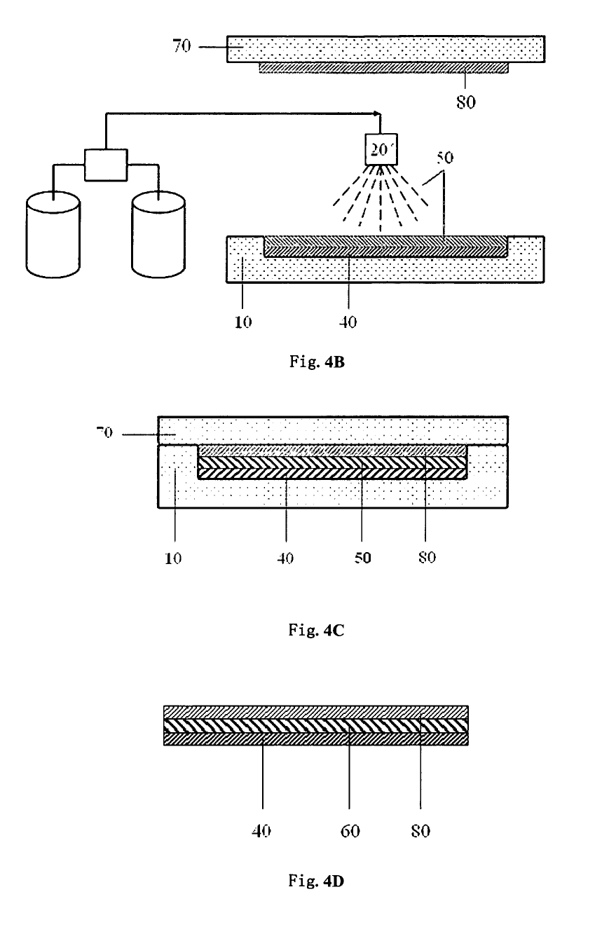

As shown in FIGS. 4A and 4B, by using CP54 type low pressure spraying machine, the polyurethane reaction system 30, DESMODUR VP.PU 0309 and BAYTEC 30BV09, were sprayed by a spraying gun nozzle 20 into the cavity of mold 10 within 20 seconds to form a polyurethane outer layer 40, wherein the thickness of the polyurethane outer layer 40 was 2.8±0.2 mm.
One minute after the polyurethane outer layer 40 being formed, by using H-XP3 type high pressure spraying machine, the polyurethane reaction system 50, DESMODUR VP.PU 10IS14 and BAYFLEX FW20FX910, were sprayed by a spraying gun nozzle 20′ onto one side of the polyurethane outer layer 40 within 16 seconds.
As shown in FIG. 4C, during the blowing process of the polyurethane reaction system 50, a mold lid 70 attached an inner layer 80 was closed. After being cured for 4 minutes and demolded, a shoe upper was obtained.
As shown in FIG. 4D, the shoe upper comprised a polyurethane outer layer 40, a polyurethane foam layer 60 and an inner layer 80. As the chemical property of the polyurethane reaction system 30 was similar to the chemical property of the polyurethane reaction system 50, there was a good adhesion effect existed between the polyurethane outer layer 40 and the polyurethane foam layer 60 without using adhesive agent. Therefore, a potential harm for environment and workers caused by using of adhesive agent was avoided. There was a good adhesion effect existed between the polyurethane foam layer 60 and the inner layer 80 without using adhesive agent.
Both of the polyurethane outer layer 40 and the polyurethane foam layer 60 comprised a surface without flaw, a uniform thickness and no pore. Both of the polyurethane outer layer 40 and the polyurethane foam layer 60 attached thereon possessed a good tactility. Both of the polyurethane outer layer 40 attached onto the polyurethane foam layer 60 and the inner layer 80 possessed a good tactility.

### Example 5

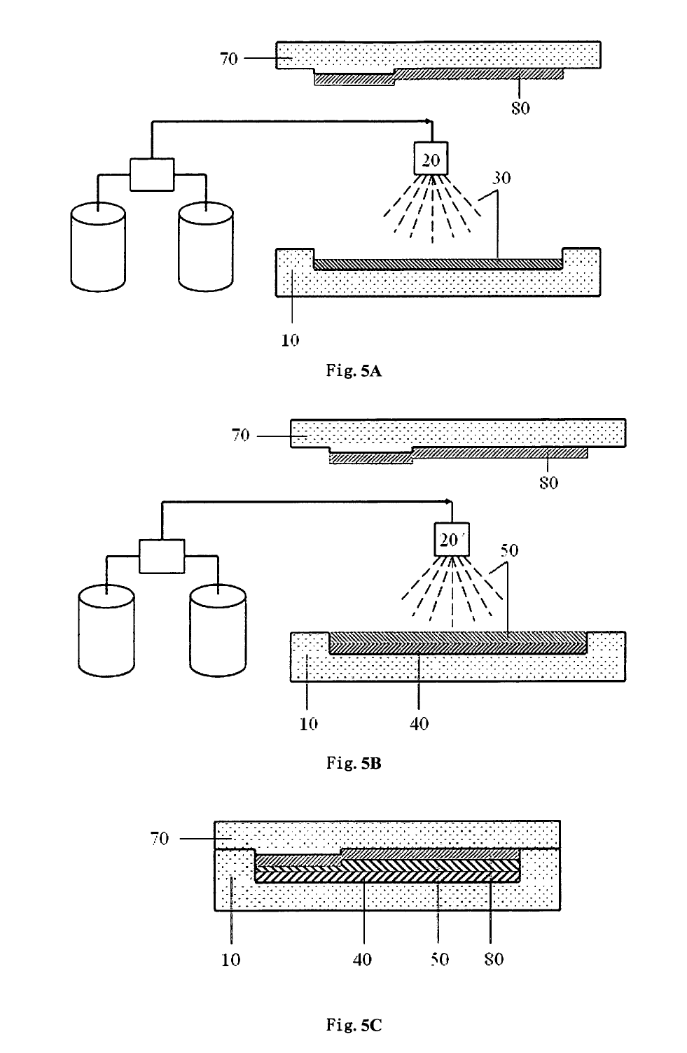

As shown in FIGS. 5A and 5B, by using CP54 type low pressure spraying machine, the polyurethane reaction system 30, DESMODUR VP.PU 0309 and BAYTEC 30BV09, were sprayed by a spraying gun nozzle 20 into the cavity of mold 10 within 12 seconds to form a polyurethane outer layer 40, wherein the thickness of the polyurethane outer layer 40 was 0.6±0.1 mm.
One minute after the polyurethane outer layer 40 being formed, by using H-XP3 type high pressure spraying machine, the polyurethane reaction system 50, DESMODUR VP.PU 10IS14 and BAYFLEX FW20FX910, were sprayed by a spraying gun nozzle 20′ onto one side of the polyurethane outer layer 40 within 25 seconds.
As shown in FIG. 5C, during the blowing process of the polyurethane reaction system 50, a mold lid 70 attached an inner layer 80 was closed.
The mold lid 70 comprised a certain concave convex pattern or a concave convex shape, wherein the concave convex pattern or a concave convex shape can be designed according to different requirements to make the shoe upper made accordantly having a nice pattern or a shape fit for the foot. The concave part of the mold lid 70 can accumulate more polyurethane reaction system 50 in the corresponding area between the polyurethane outer layer 40 and the inner layer 80 to form a more thick polyurethane foam in this corresponding area. The convex part of the mold lid 70 can accumulate fewer polyurethanereaction system 50 in the corresponding area between the polyurethane outer layer 40 and the inner layer 80 to form a more thin polyurethane foam in this corresponding area. After being cured for 3 minutes and demolded, a shoe upper was obtained.
As shown in FIG. 5D, the shoe upper comprised a polyurethane outer layer 40, a polyurethane foam layer 60 and an inner layer 80. As the chemical property of the polyurethane reaction system 30 was similar to the chemical property of the polyurethane reaction system 50, there was a good adhesion effect existed between the polyurethane outer layer 40 and the polyurethane foam layer 60 without using adhesive agent. Therefore, a potential harm for environment and workers caused by using of adhesive agent was avoided. There was a good adhesion effect existed between the polyurethane foam layer 60 and the inner layer 80 without using adhesive agent. Both of the polyurethane outer layer 40 and the polyurethane foam layer 60 comprised a surface without flaw, a uniform thickness and no pore. The polyurethane foam layer 60 and the inner layer 80 attached thereon possessed a same convex concave pattern or convex concave shape corresponding to the convex concave pattern or convex concave shape on the mold lid 70.

The surface of the polyurethane outer layer 40, which was obtained by spraying, comprised a convex concave pattern or convex concave shape corresponding to the concave convex pattern or a concave convex shape on the mold base of the shoe upper mold 10. Both of the polyurethane outer layer 40 attached onto the polyurethane foam layer 60 and the inner layer 80 possessed a good tactility.

### Example 6

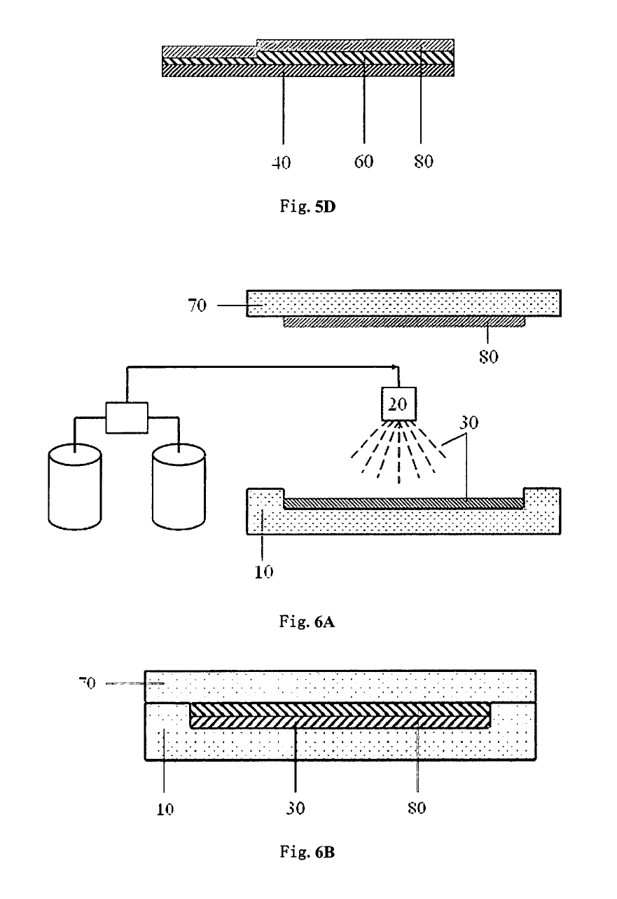

As shown in FIG. 6A, by using CP54 type low pressure spraying machine, the polyurethane reaction system 30, DESMODUR VP.PU 0309 and BAYTEC 30BV09, were sprayed by a spraying gun nozzle 20 into the cavity of mold 10 within 12 seconds.
As shown in FIG. 6B, during the blowing process of the polyurethane reaction system 30, a mold lid 70 attached an inner layer 80 was closed.
As shown in FIG. 6C, the shoe upper comprised a polyurethane outer layer 40 and an inner layer 80, wherein the thickness of the polyurethane outer layer 40 was 1.0±0.3 mm. Both of the polyurethane outer layer 40 and the inner layer 80 attached thereon possessed a good tactility.

### Example 7

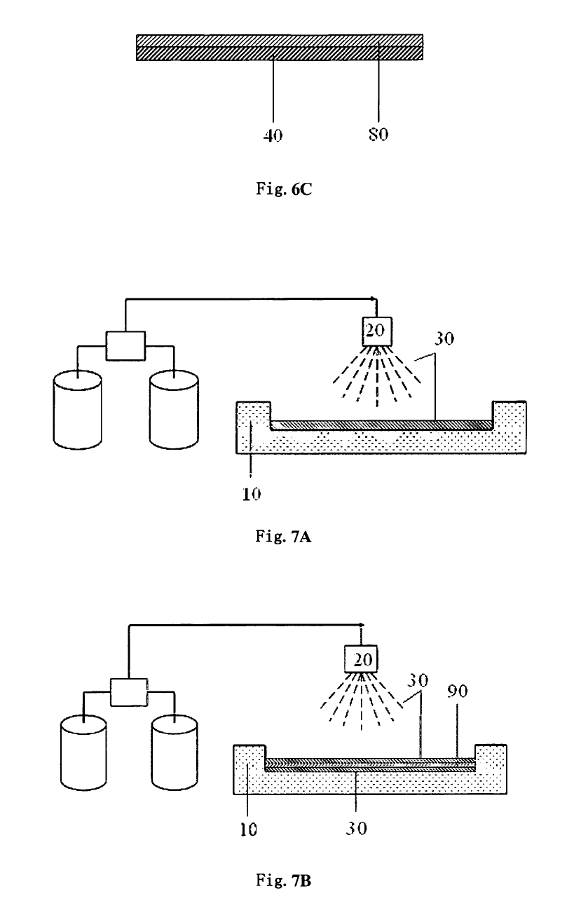

As shown in FIGS. 7A and 7B, by using CP54 type low pressure spraying machine, the polyurethane reaction system 30, DESMODUR VP.PU 0309 and BAYTEC 30BV09, were sprayed by a spraying gun nozzle 20 into the cavity of mold 10 within 5 seconds. During the blowing process of the polyurethane reaction system 30, a fabric layer 90 attached onto the polyurethane reaction system 30.
The polyurethane reaction system 30 for preparing polyurethane outer layer, DESMODUR VP.PU 0309 and BAYTEC 30BV09, was sprayed onto the other side of the fabric layer to make the polyurethane reaction system 30 to cover both side of the fabric layer. After being cured for 3 minutes and demolded, a shoe upper was obtained.
As shown in FIG. 7C, the shoe upper comprised a polyurethane outer layer 40 and a fabric layer 90, wherein the thickness of the polyurethane outer layer 40 was 1.0±0.1 mm. There was a good adhesion effect existed between the fabric layer 90 and polyurethane outer layer 40 without using adhesive agent. Therefore, a potential harm for environment and workers caused by using of adhesive agent was avoided. The polyurethane outer layer 40 not only comprised a surface without flaw and a uniform thickness, but also possessed a good tactility.

### Example 8

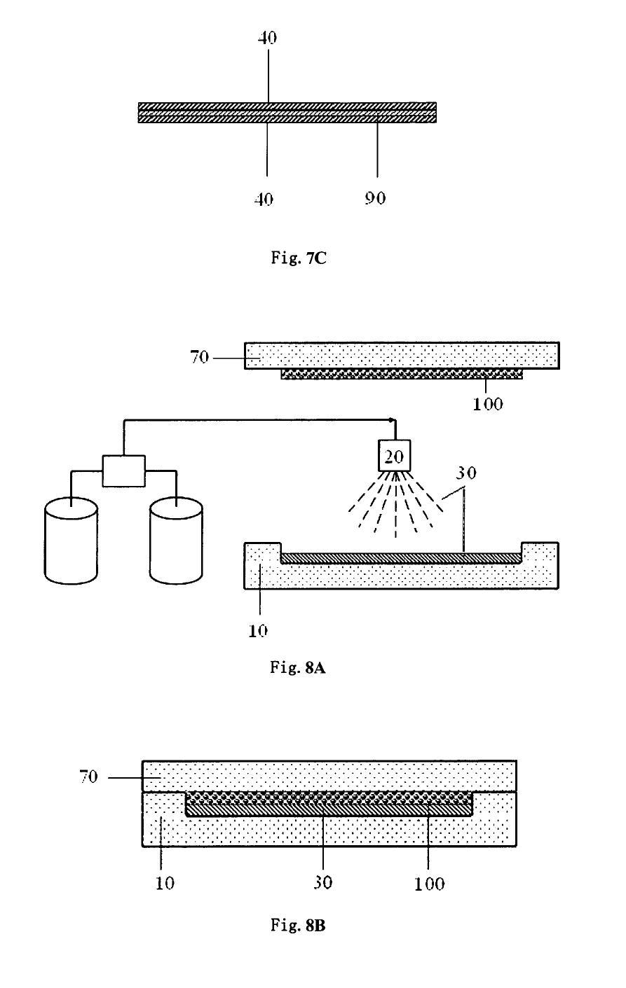

As shown in FIG. 8A, by using CP54 type low pressure spraying machine, the polyurethane reaction system 30, DESMODUR VP.PU 0309 and BAYTEC 30BV09, were sprayed by a spraying gun nozzle 20 into the cavity of mold 10 within 10 seconds.
As shown in FIG. 8B, during the blowing process of the polyurethane reaction system 30, a mold lid 70 attached a pre-formed foam layer 100 was closed. After being cured for 3 minutes and demolded, a shoe upper was obtained.
As shown in FIG. 8C, the shoe upper comprised a polyurethane outer layer 40 and a pre-formed foam layer 100, wherein the thickness of the polyurethane outer layer 40 was 1.0±0.3 mm. There was a good adhesion effect existed between the pre-formed foam layer 100 and polyurethane outer layer 40 without using adhesive agent. Therefore, a potential harm for environment and workers caused by using of adhesive agent was avoided. The polyurethane outer layer 40 not only comprised a surface without flaw and a uniform thickness, but also possessed a good tactility.

### Example 9

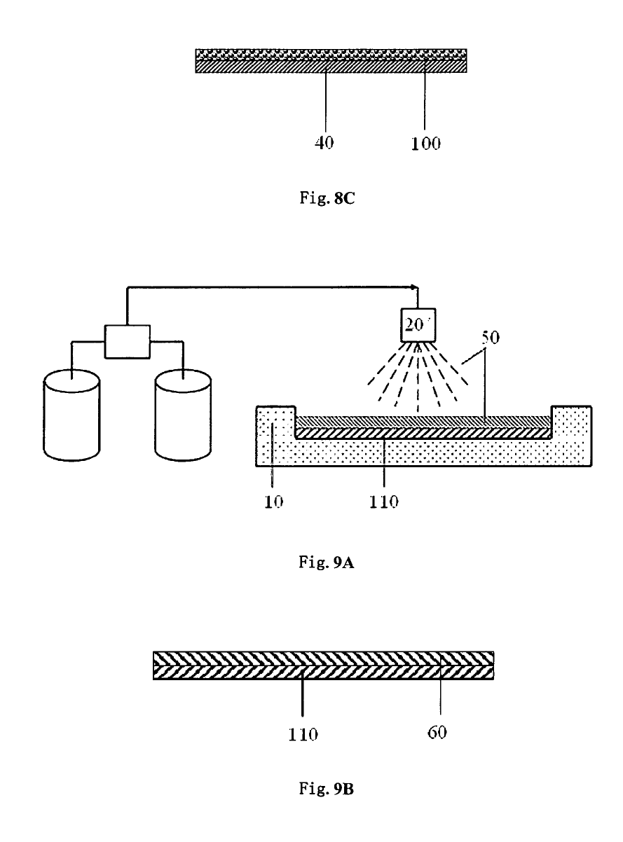

As shown in FIG. 9A, a leather layer 110 without joint seam (lapped seam or butt seam) was fixed in the mold 10, wherein thickness of the leather layer 110 was 1.2 mm. By using H-XP3 type high pressure spraying machine, the polyurethane reaction system 50, DESMODUR VP.PU 10IS14 and BAYFLEX FW20FX910, were sprayed by a spraying gun nozzle 20′ onto one side of the leather layer 110 within 20 seconds. After being cured for 3 minutes and demolded, a shoe upper was obtained.
As shown in FIG. 9B, the shoe upper comprised a leather layer 110 and a polyurethane foam layer 60. There was a good adhesion effect existed between the leather layer 110 and the polyurethane foam layer 60 without using adhesive agent. Therefore, a potential harm for environment and workers caused by using of adhesive agent was avoided. The polyurethane foam layer 60 not only comprised a surface without flaw, a uniform thickness and no small hole. The shoe upper was not harded obviously, furthermore, both of the polyurethane foam layer 60 and the leather layer 110 possessed a good tactility.

### Example 10

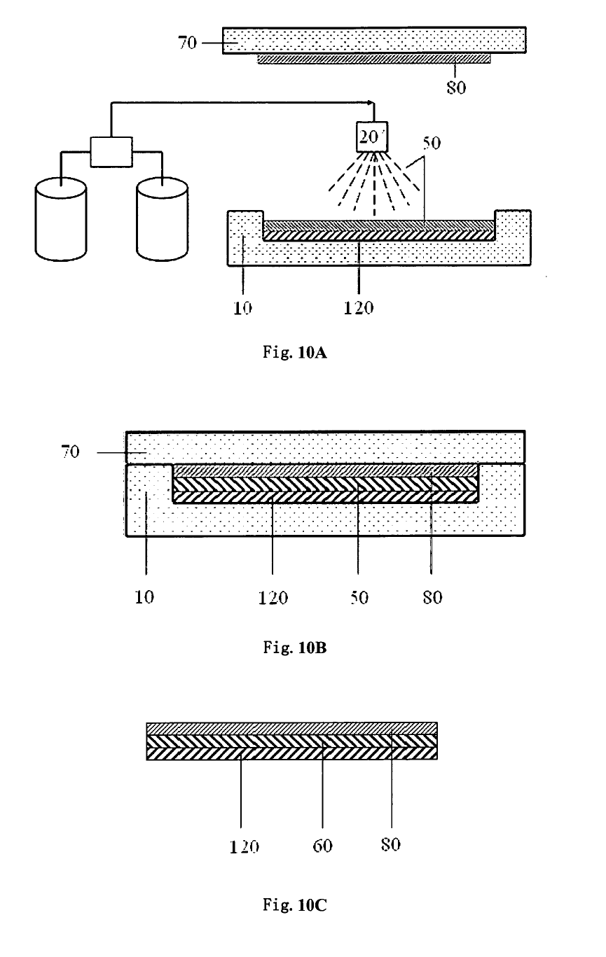

As shown in FIG. 10A, a leather layer 120 with joint seam (lapped seam or butt seam) was fixed in the mold 10, wherein thickness of the leather layer 120 was 0.8 mm a polyurethane rubber adhesive agent was spread on one side of the leather layer 120 to prevent the polyurethane reaction system penetrating the joint seam during the spraying process. By using H-XP3 type high pressure spraying machine, the polyurethane reaction system 50, DESMODUR VP.PU 10IS14 and BAYFLEX FW20FX910, were sprayed by a spraying gun nozzle 20′ onto one side of the leather layer 120 within 16 seconds.
As shown in FIG. 10B, the shoe upper comprised a leather layer 120 and a polyurethane foam layer 60. There was a good adhesion effect existed between the leather layer 120 and the polyurethane foam layer 60 without using adhesive agent. Therefore, a potential harm for environment and workers caused by using of adhesive agent was avoided. The polyurethane foam layer 60 not only comprised a surface without flaw, a uniform thickness, a uniform foam structure and no pore. Both of the polyurethane foam layer 60 and the leather layer 120 possessed a good tactility.

Although the present invention is illustrated through Examples, it is not limited by these Examples in any way. Without departing from the spirit and scope of this invention, those skilled in the art can make any modifications and alternatives. And the protection of this invention is based on the scope defined by the claims of this application.

1-27. (canceled)

28. A method for preparing a shoe upper comprising a first polyurethane layer which comprises spraying a first polyurethane reaction system to form the first polyurethane layer.

29. The method as claimed in claim 28 further comprising a step of spraying a second polyurethane reaction system onto one side of the first polyurethane layer to form a second polyurethane layer.

30. The method as claimed in claim 29 further comprising a step of attaching an inner liner to the second polyurethane reaction system before the second polyurethane layer is formed to form a shoe upper comprising the first polyurethane layer, the second polyurethane layer and the inner liner.

31. The method as claimed in claim 28 further comprising a step of attaching an inner liner onto the first polyurethane reaction system before the first polyurethane layer is formed to form a shoe upper comprising the first polyurethane layer and the inner liner.

32. The method as claimed in claim 28 further comprising a step of attaching a pre-formed foam layer onto the first polyurethane reaction system before the first polyurethane layer is formed to form a shoe upper comprising the first polyurethane layer and the pre-formed foam layer.

33. The method as claimed in claim 28, wherein, the first polyurethane reaction system comprises:
(a) a polyisocyanate, wherein the general formula of the polyisocyanate is R(NCO)n, where R represents a substituent selected from the group consisting of aliphatic alkyl having 2-18 carbon atoms, aromatic alkyl having 6-15 carbon atoms, and aromatic lipid alkyl having 8-15 carbon atoms; and n is an integer from 2 to 4;
(b) a polyol selected from the group consisting of polyester polyol, polyether polyol, and aliphatic polycarbonate;
(c) a chain extender; and
(d) from 0.01 to 0.5 wt. % of a blowing agent, based on 100 wt. % of components (b) and (c).

34. The method as claimed in claim 29, wherein, the second polyurethane reaction system comprises:
(a) a polyisocyanate, wherein the general formula of the polyisocyanate is R(NCO)n, where R represents a substituent selected from the group consisting of aliphatic alkyl having 2-18 carbon atoms, aromatic alkyl having 6-15 carbon atoms, and aromatic lipid alkyl having 8-15 carbon atoms; and n is an integer from 2 to 4;
(b) a polyol selected from the group consisting of polyester polyol, polyether polyol, and aliphatic polycarbonate;
(c) a chain extender; and
(d) from 0.3 to 4.5 wt. % of a blowing agent, based on 100 wt. % of components (b) and (c).

35. The method as claimed in claim 28, wherein the thickness of the first polyurethane layer is from 0.5 to 3.0 mm.

36. The method as claimed in claim 28, wherein the first polyurethane reaction system is sprayed into a shoe upper mold to form the first polyurethane layer.

37. The method as claimed in claim 28 further comprising a step of spraying the first polyurethane reaction system onto one side of a leather layer to form the first polyurethane layer.

38. The method as claimed in claim 37 further comprising a step of attaching an inner liner onto the first polyurethane reaction system before the first polyurethane layer is formed, wherein the first polyurethane reaction system is sprayed on one side of the leather layer to form a shoe upper comprising the first polyurethane layer and the leather layer.

39. The method as claimed in claim 37, wherein the first polyurethane reaction system comprises:
(a) a polyisocyanate, wherein the general formula of the polyisocyanate is R(NCO)n, where R represents a substituent selected from the group consisting of aliphatic alkyl having 2-18 carbon atoms, aromatic alkyl having 6-15 carbon atoms, and aromatic lipid alkyl having 8-15 carbon atoms; and n is an integer from 2 to 4;
(b) a polyol selected from the group consisting of polyester polyol, polyether polyol, and aliphatic polycarbonate;
(c) a chain extender; and
(d) from 0.3 to 4.5 wt. % of a blowing agent, based on 100 wt. % of components (b) and (c).

40. A shoe upper comprising a first polyurethane layer, wherein, said first polyurethane layer is formed by spraying a first polyurethane reaction system.

41. The shoe upper as claimed in claim 40 further comprising a second polyurethane layer, wherein, said second polyurethane layer is formed by spraying a second polyurethane reaction system onto one side of the first polyurethane layer.

42. The shoe upper as claimed in claim 41 further comprising an inner liner, wherein said inner liner is, attached onto the second polyurethane reaction system before the second polyurethane layer is formed.

43. The shoe upper as claimed in claim 40 further comprising an inner liner, wherein, said inner liner is, attached onto the first polyurethane reaction system before the first polyurethane layer is formed.

44. The shoe upper as claimed in claim 40 further comprising a pre-formed foam layer, wherein said pre-formed foam layer is, attached onto the first polyurethane reaction system before the first polyurethane layer is formed.

45. The shoe upper as claimed in claim 40, wherein the first polyurethane reaction system comprises:
(a) a polyisocyanate, wherein the general formula of the polyisocyanate is R(NCO)n, where R represents a substituent selected from the group consisting of aliphatic alkyl having 2-18 carbon atoms, aromatic alkyl having 6-15 carbon atoms, and aromatic lipid alkyl having 8-15 carbon atoms; and n is an integer from 2 to 4;
(b) a polyol selected from the group consisting of polyester polyol, polyether polyol, and aliphatic polycarbonate;
(c) a chain extender; and
(d) from 0.01 to 0.5 wt. % of a blowing agent, based on 100 wt. % of components (b) and (c).

46. The shoe upper as claimed in claim 41, wherein, the second polyurethane reaction system comprises:
(a) a polyisocyanate, wherein the general formula of the polyisocyanate is R(NCO)n, where R represents a substituent selected from the group consisting of aliphatic alkyl having 2-18 carbon atoms, aromatic alkyl having 6-15 carbon atoms, and aromatic lipid alkyl having 8-15 carbon atoms; and n is an integer from 2 to 4;
(b) a polyol selected from the group consisting of polyester polyol, polyether polyol, and aliphatic polycarbonate;
(c) a chain extender; and
(d) from 0.3 to 4.5 wt. % of a blowing agent, based on 100 wt. % of components (b) and (c).

47. The shoe upper as claimed in claim 40, wherein the thickness of the first polyurethane layer is from 0.5 to 3.0 mm.

48. The shoe upper as claimed in claim 40, wherein the first polyurethane layer is formed by spraying the first polyurethane reaction system into a shoe upper mold.

49. The shoe upper as claimed in claim 40 further comprising a leather layer, wherein, the first polyurethane layer is formed by spraying the first polyurethane reaction system onto one side of the leather layer.

50. The shoe upper as claimed in claim 49 further comprising an inner liner, wherein said inner liner is attached onto the first polyurethane reaction system before the first polyurethane layer is formed.

51. The shoe upper as claimed in claim 49, wherein, the first polyurethane reaction system comprises:
(a) a polyisocyanate, wherein the general formula of the polyisocyanate is R(NCO)n, where R represents a substituent selected from the group consisting of aliphatic alkyl having 2-18 carbon atoms, aromatic alkyl having 6-15 carbon atoms, and aromatic lipid alkyl having 8-15 carbon atoms; and n is an integer from 2 to 4;
(b) a polyol selected from the group consisting of polyester polyol, polyether polyol, and aliphatic polycarbonate;
(c) a chain extender; and
(d) from 0.3 to 4.5 wt. % of a blowing agent, based on 100 wt. % of components (b) and (c).

52. A shoe comprising a shoe upper as claimed in claim 40.

53. The shoe as claimed in claim 52, wherein the shoe is a sports shoe, climbing shoe or safety shoe.

54. A method of preparing a shoe, wherein the improvement comprises utilizing the shoe upper as claimed in claim 40.
